(19) United States
(12) Patent Application Publication
(10) Pub. No.: US 2003/0041025 A1
(43) Pub. Date: Feb. 27, 2003

(54) System and method for flexible promotional rates

(75) Inventors: David S. Bonalle, New Rochelle, NY (US); Helene Bourgogne, New York, NY (US); Eric Gerard S. Dapon, Cave Creek, AZ (US); Mary G. Rances, Huntington, NY (US); Gabi Schaefer, Davie, FL (US)

Correspondence Address: SNELL & WILMER, ONE ARIZONA CENTER, 400 EAST VAN BUREN, PHOENIX, AZ, 850040001

(73) Assignee: AMERICAN EXPRESS TRAVEL RELATED SERVICES COMPANY INC.

(21) Appl. No.: 10/227,370

(22) Filed: Aug. 23, 2002

Related U.S. Application Data
(60) Provisional application No. 60/314,404, filed on Aug. 23, 2001.

(51) Int. Cl. G06F 17/60

(52) U.S. Cl. 705/39; 705/38; 705/35

(57) ABSTRACT

The present invention includes a system and method for facilitating the customization of a transaction card having a set interest rate by allowing a consumer to choose when to use the promotional rate or customize other promotional offers. The consumer can select or customize the offer by telephoning a consumer service agent or entering the request via the Internet. The system adjusts the set interest rate to be equivalent to the promotional interest rate such that the promotional interest rate is activated on the calendar date and during the promotional time period.

### CROSS-REFERENCE TO RELATED APPLICATIONS

This application claims priority to, and the benefit of, U.S. Provisional Application serial No. 60/314,404, filed Aug. 23, 2001, the entire contents of which is hereby incorporated by reference.

### FIELD OF THE INVENTION

The invention generally relates to promotional rates for transaction cards, and more particularly, to a system and method for facilitating a consumer's ability to choose or customize a promotional offer related to a transaction card.

### BACKGROUND OF THE INVENTION

After applying and qualifying for a new transaction card account (e.g., credit or charge card), a consumer typically receives a card and/or account number with an associated finance charge for any late payments or unpaid balances. The finance charge is usually calculated from an interest rate which is applied to any unpaid balance by a pre-established due date. Many consumers are incented to apply for new transaction cards, or continue with existing transaction cards, because of promotions that are offered with the cards. The promotions may include, for example, low interest rates, promotional interest rates for fixed periods of time, rebates, higher credit limits, reduced annual fees, discounts on products, coupons, membership into clubs, loyalty programs, free products or free services. Transaction card issuers are also typically looking for new, innovative promotions to attract additional consumers into becoming cardmembers. Moreover, issuers often desire to provide additional promotions that increase the use of the transaction cards during purchase transactions.

Many current promotional interest rates for transaction cards are offered at a set rate for a set time period. For example, a 0% rate is offered for the initial 3-6 months from activation of the credit card. However, consumers often desire more flexibility when utilizing promotions such that the consumer may be able to save more money or reduce interest expenses during certain time periods. For example, a consumer may desire to reduce his interest rate during certain months in which the consumer will be charging larger amounts of purchases on the transaction card. Additionally, a consumer may desire to reduce his interest rate during certain months when income is lower and/or expenses are higher. While the card issuer may be able to offer supplemental promotional rates beyond the introductory period, the marketing and campaign costs associated with notifying cardmembers of the promotion may be cost prohibitive. Furthermore, many card issuers will offer a reduced interest rate during a certain time period; however, the reduced rate promotion is typically limited to a set reduction during a set time period for a certain group of cardmembers only. Additionally, consumers could attempt to switch to another transaction card product to obtain a better rate; however, too many inconveniences exist such as, for example, the application process, switching automatic payments, and waiting for a new card. As such, a need exists for a system and method, which allows the consumer to change the interest rate associated with an existing transaction card during any time period, which is desired, by the consumer.

### SUMMARY OF THE INVENTION

The present invention includes a system and method for facilitating the customization of a transaction card having a set interest rate. In an exemplary embodiment, the present invention allows the consumer to choose when to use the promotional rate or customize other promotional offers 44. The consumer can select or customize the offer by telephoning a consumer service agent or entering the request via the Internet. An exemplary method includes storing an available promotional interest rate associated with the transaction card, along with a promotional time period for activating the promotional interest rate; receiving a calendar date upon which to activate the promotional interest rate; adjusting the set interest rate to be equivalent to the promotional interest rate such that the promotional interest rate is activated on the calendar date and during the promotional time period; and, billing a finance charge based upon the promotional interest rate.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same or similar system parts and/or method steps in the similar views, and:

FIG. 1 is an exemplary schematic system configuration in accordance with the present invention; and,

FIG. 2 is an exemplary flowchart of a method of the present invention.

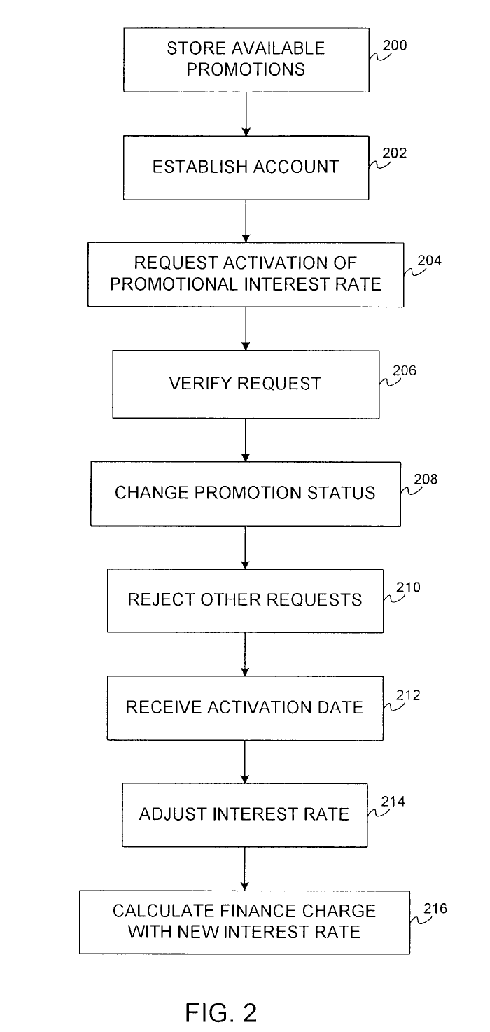

### DETAILED DESCRIPTION OF EXEMPLARY EMBODIMENTS

In the typical situation, a consumer 10 applies for a transaction card 12, and if qualified, the issuer sends the consumer 10 a transaction card 12 having an account number 14 associated with a transaction account 34, wherein the transaction account includes a line of credit with a credit limit 30 and a pre-disclosed set interest rate 36. The account number 14 may be used by the consumer 10 to charge purchases to the transaction account. With respect to a purchase transaction, after obtaining authorization for the account number 14 and the purchase amount from the card issuer (e.g., American Express, bank or other financial institution), the merchant 18 requests settlement of the charge from the card issuer and the card issuer pays the merchant 18 the value of the charge. The card issuer then sends a bill to the consumer 10 requesting payment by a certain date of the recent charges associated with the transaction account. If the consumer 10 does not pay the entire amount of the charges, the issuer may add a finance charge related to the unpaid balance on the next billing statement.

In various embodiments of the present invention, during the application process for a transaction card or at any other time, the card issuer may provide a promotion to a consumer 10 which may include, for example, low interest rates 36, change monthly minimum payment due, promotional interest rates for fixed periods of time, rebates, higher credit limits, reduced annual fees, discounts on products, coupons, membership into clubs, loyalty programs, free products, free services and/or the like. In an exemplary embodiment, the present invention facilitates the customization of any of these promotional offers associated with the transaction account. The customization may include adjusting the rates 36, fees, discounts and/or any of the other promotional factors 44. The adjustment of the promotions may include adjustments during a desired time period. The adjustments may also include adjustments, which start at a certain date, and/or time, but the duration of the promotion may be set by the issuer. The adjustments may also include adjustments to any of the consumer's 10 transaction accounts, any associated accounts, any associated programs (e.g., frequent flyer, hotel points, loyalty programs and/or the like) and/or any accounts selected by the consumer 10, issuer or merchant 18. For example, the system may allow the consumer 10 to lower the promotional rate for the charge card account of the consumer's 10 teenage son during the month before the son starts school because the mother knows that the son may be charging a large amount to the charge card during that month for school supplies and new clothes.

In one embodiment of the present invention, a system and method facilitates the customization of a transaction card having a set interest rate by allowing the consumer 10 to choose when to substitute a promotional interest rate for the set interest rate. For example, the business can offer 0% for the first 3 months, then allow the consumer 10 to choose any other 3 months to implement the 0% rate. The selected rate would be effective at any desired time, and in one embodiment, during the next billing cycle after the selection is entered. While the temporary reduction of the interest rate is discussed in detail herein, one skilled in the art will appreciate that the system and method of the present invention may facilitate the implementation and customization of any of the other promotional examples discussed herein. Moreover, one skilled in the art will appreciate that any type of interest rate or finance charge arrangement may be contemplated by the present invention such as, for example, a constant interest rate, a varying interest rate, an interest rate that adjusts throughout different time periods, application of the interest rate to any portion of the charges or balance, interest rates that are due weekly, monthly, yearly or any other time period, interest rates based on other factors (e.g., membership status, economic indicators, etc) and/or the like.

As discussed herein, “consumer” includes any individual, business, entity, merchant 18, hardware and/or software that desires to possess or possesses an account number 14 associated with a transaction account. In an exemplary embodiment, the consumer 10 establishes a new or has an existing relationship or association, either directly or indirectly, with a host 20. For example, in one embodiment, a consumer 10 may be an American Express® card member. In another embodiment, a consumer 10 may be a participant in a frequent flyer rewards program. Another embodiment contemplates the consumer 10 receiving the account number 14 from a second party, such that the account number 14 is utilized as a supplemental account or as a limited use account number 14.

“Merchant” includes any individual, entity, business, website, retailer, manufacturer, distributor, financial institution, issuer, acquirer, consumer 10, hardware and/or software that receives an account number 14 to facilitate a transaction, whether or not in exchange for goods or services. For example, in one embodiment, a merchant 18 may be an online bookstore such as Amazon.com®. In another embodiment, a merchant 18 may be a local hardware store. Although referred to herein as a “merchant”, this term contemplates situations where any second party receives an account number 14 and is suitably configured to communicate with the host controller 22 22 to process the consumer 10 transaction request.

Host 20 includes any individual, consumer, merchant 18, entity, bank, financial institution, issuer, acquirer, hardware and/or software that facilitates any type of transaction. As contemplated by an exemplary embodiment of the present invention,, the host 20 establishes and maintains account and/or transaction information 35 for the consumer processes merchant 18 authorization requests and/or facilitates transaction settlements. The host 20 may issue account numbers and/or transaction cards to the consumer 10 and may also provide both the consumer 10 and the merchant 18 with the processes to facilitate the transaction system of the present invention. The host 20 includes, for example, banks; credit unions; credit, debit or other transaction-related companies, telephone companies; or any other type of card or account issuing institutions, such as card-sponsoring companies, incentive rewards companies, and/or third party providers under contract with financial institutions. Unless otherwise specifically set forth herein, although referred to as “host 20,” this term should be understood to mean any entity issuing any type of account to facilitate any transaction, exchange and/or service; and should not be limited to companies possessing or issuing physical cards. It is further noted that other participants may be involved in some phases of the transaction, such as an intermediary settlement institution, but these participants are not shown. In an exemplary system, the host 20 may be any transaction facilitating company such as a charge/credit card provider like American Express®, VISA®, Mastercard®, Discover®, etc.

As used herein, a “transaction” includes any exchange or delivery of value, exchange or delivery of data, gifting of value or data, etc. The term transaction not only contemplates an exchange of goods or services for value from one party to another, but also the gifting of anything from one party to another. Additionally, transaction account numbers include account numbers that are used to facilitate any type of transaction. As used herein, “account number 14” includes any device, code, number, letter, symbol, biometric or other identifier/indicia suitably configured to allow the consumer 10 to interact or communicate with the system, such as, for example, authorization code, access code, personal identification number (PIN), Internet code, other identification code, and/or the like which is optionally located on a rewards card, charge card, credit card, debit card, prepaid card, telephone card, smart card, magnetic stripe card, bar code card, transponder, radio frequency card and/or the like. The account number 14 may be distributed and stored in any form of plastic, electronic, magnetic, radio frequency, wireless, audio and/or optical device capable of transmitting or downloading data from itself to a second device. With respect to the account number 14, it should be appreciated that the number may be, for example, a sixteen-digit credit card number, although each card provider may have its own numbering system, such as the fifteen-digit numbering system used by American Express®. Each company's card numbers comply with that company's standardized format such that a company using a sixteen-digit format will generally use four spaced sets of numbers, as represented by the number “0000 0000 0000 0000.” The first five to seven digits are reserved for processing purposes and identify the issuing bank, card type etc. In this example, the last sixteenth digit is used as a sum check for the sixteen-digit number. The intermediary eight-to-ten digits are used to uniquely identify the consumer 10. The invention contemplates the use of other numbers, indicia, codes or other security steps in addition to the use of the account number 14.

The system may include a host 20 server, data processing system or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, merchant 18 data, financial institution data and/or like data that could be used in association with the present invention. As those skilled in the art will appreciate, consumer 10 computer will typically include an operating system (e.g., Windows NT, 95/98/2000, Linux, Solaris, etc.) as well as various conventional support software and drivers typically associated with computers. Consumer computer can be in a home or business environment with access to a network. In an exemplary embodiment, access is through the Internet through a commercially-available web-browser software package.

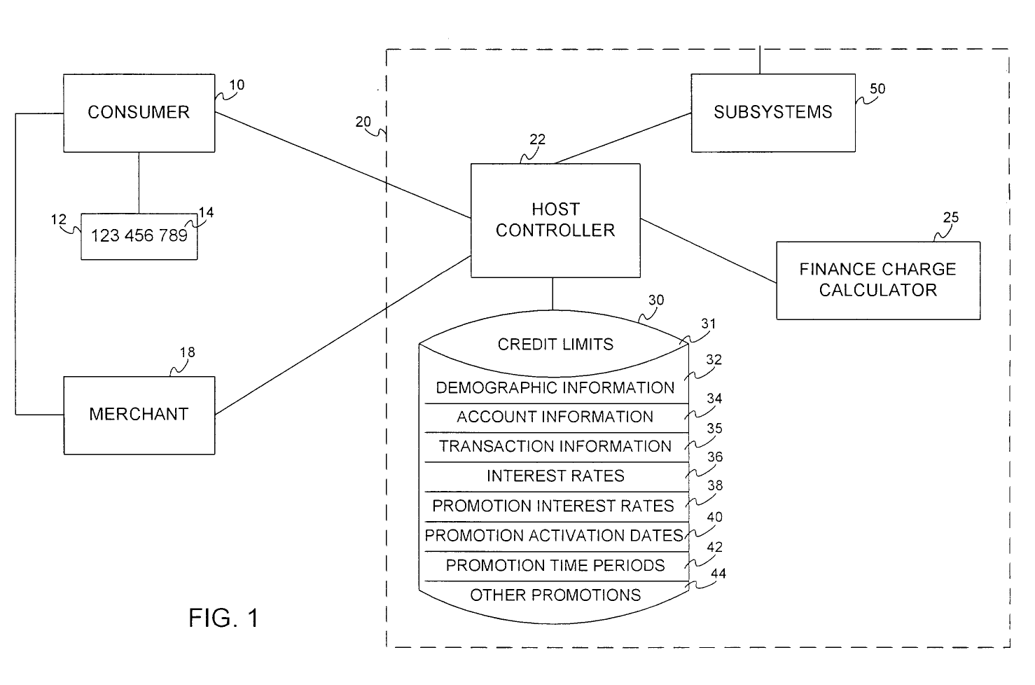

In an exemplary embodiment of the present invention, and as shown in FIG. 1, the system includes a consumer 10 and a host 20 system with may interface and communicate by any means discussed herein. Host 20 system comprises one or more interface systems configured to facilitate communication with one or more consumers 10 and/or one or more merchant 18s. The interface systems are generally configured to route and communicate consumer 10 or merchant 18 data to any of the subsystems 50. The subsystems 50 of the host 20 system include any hardware and/or software generally configured to facilitate transaction settlement, i.e., payment of merchant 18 and invoicing of consumer 10. Subsystems 50 may include, for example, a card authorization system (CAS), a financial capture system (FINCAP) for capturing the merchant 18's receipt and summary of charges, an accounts receivable system for adjusting the account and billing consumer 10, an accounts payable system for paying the merchant 18, other settlement systems, a new accounts system (NAS) and/or any other subsystems 50 suitably configured to facilitate any of the functions of the charge card transaction. In a traditional financial infrastructure, the accounts receivable system may be the same as the credit card system. As those skilled in the art will appreciate, any hardware, software and/or systems discussed herein may be included within one host 20 or distributed among many locations or entities. Moreover, any portion of the host 20 system or consumer 10 system may be incorporated onto a portable device, such as a smart card or personal digital assistant.

The host 20 system also comprises a controller 22, finance charge calculator 25 and databases 30. Finance charge calculator 25 is any software and/or hardware suitably configured to receive data and/or instructions from host 20 system components and calculate the appropriate finance charge associated with a consumer 10 account. Databases may include information related to, for example, credit limits 30, demographic data, account information 34, transaction information 35, interest rate, promotional interest rate, promotional activation date 40, promotional time period 42, other promotion data 44, reordering checks, military status, secondary signatures, effective date, forgiveness indicators, rush check order, activate flexible introduction for the promotional interest rate, activation date for the flexible introduction for the promotional interest rate and/or any other data which may be used in the present invention. The databases (e.g., 30) discussed herein may be located in one database or distributed among various databases. The databases may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

Communication between the parties to the transaction and the system of the present invention may be accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The computing units may be connected with each other via a data communication network. The network may be a public network and assumed to be insecure and open to eavesdroppers. In the illustrated implementation, the network may be embodied as the internet. In this context, the computers may or may not be connected to the internet at all times. For instance, the consumer 10 computer may employ a modem to occasionally connect to the internet, whereas the bank computing center might maintain a permanent connection to the internet. Specific information related to the protocols, standards, and application software utilized in connection with the Internet may not be discussed herein. For further information regarding such details, see, for example, Dilip Naik, Internet Standards And Protocols (1998); Java 2 Complete, Various Authors, (Sybex 1999); Deborah Ray And Eric Ray, Mastering Html 4.0 (1997). Loshin, TCP/IP Clearly Explained (1997). All of these texts are hereby incorporated by reference.

The systems may be suitably coupled to network via data links. A variety of conventional communications media and protocols may be used for data links. Such as, for example, a connection to an Internet Service Provider (ISP) over the local loop as is typically used in connection with standard modem communication, cable modem, Dish networks, ISDN, Digital Subscriber Line (DSL), or various wireless communication methods. Merchant 18 system might also reside within a local area network (LAN), which interfaces to network via a leased line (T1, D3, etc.). Such communication methods are well known in the art, and are covered in a variety of standard texts. See, e.g., Gilbert Held, Understanding Data Communications (1996), hereby incorporated by reference.

Each participant in the present invention may be equipped with a computing system to facilitate online commerce transactions. The consumer 10 may utilize a computing unit in the form of a personal computer, although other types of computing units may be used including laptops, notebooks, hand held computers, set-top boxes, point of sale devices and/or the like. The merchant 18 has a computing unit implemented in the form of a computer-server, although other implementations are possible. The bank or card issuer may have a computing center such as a main frame computer. However, the bank computing center may be implemented in other forms, such as a mini-computer, a PC server, a network set of computers, and/or the like.

The merchant 18 computer and the bank computer may be interconnected via a second network, referred to as a payment network. The payment network represents existing proprietary networks that presently accommodate transactions for credit cards, debit cards, and other types of financial/banking cards. The payment network is a closed network that is assumed to be secure from eavesdroppers. Examples of the payment network include the American Express®, VisaNet® and the Veriphone® network. While an exemplary embodiment of the invention is described in association with a financial transaction system, the invention contemplates any type of networks or transaction systems, including, for example, unsecure networks, public networks, wireless networks, closed networks, open networks, intranets, extranets, and/or the like.

The electronic commerce system of the present invention may be implemented at the consumer 10 and issuing bank. In an exemplary implementation, the electronic commerce system is implemented as computer software modules loaded onto the consumer 10 computer and the banking computing center. The merchant 18 computer may not require any additional software to participate in the online commerce transactions supported by the online commerce system.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, the following may be helpful references: (1) Applied Cryptography: Protocols, Algorithms, And Source Code In C, by Bruce Schneier, published by John Wiley & Sons (second edition, 1996); (2) Java Cryptography by Jonathan Knudson, published by O'Reilly & Associates (1998); (3) Cryptography & Network Security: Principles & Practice by William Stalling, published by Prentice Hall; all of which are hereby incorporated by reference.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

It should also be appreciated that many applications of the present invention could be formulated. One skilled in the art will appreciate that the system may include any system for exchanging data or transacting business, such as the Internet, an intranet, an extranet, WAN, LAN, satellite communications, and/or the like. It is noted that the network may be implemented as other types of networks, such as an interactive television (ITV) network. The consumers 10 may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, flash card memory and/or the like.

The computer may provide a suitable website or other Internet-based graphical consumer 10 interface which is accessible by consumers 10. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access Sequel Server, Oracle, MySQL, Intervase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

With respect to the method for implementing the present invention, the system is configured with numerous data fields arranged in databases as discussed above, including, for example, an “Activate Flexible Intro (Y or N)” field and a “Activation Date (YY/MM)” field. The system also stores available promotion information, rates and time periods in the relevant databases (step 200). In one embodiment, the system stores a promotional interest rate (e.g., 0%) in promotional interest rate database, which is associated with the time period for activation (e.g., 3 months) of the promotional interest rate 36 in promotional time period database 42.

The consumer 10 may first provide data sufficient to obtain approval to establish a credit card account or to change any of the parameters associated with the account (step 202). The system may then inform the consumer 10 of promotional offers that the consumer 10 can select in accordance with the present invention. At any time during the process, the consumer 10 may request that the promotional interest rate associated with a certain account number 14 be activated (step 204) by contacting the host 20 system by any means discussed herein or known in the art such as, for example, telephoning a consumer 10 service agent or entering the request via the Internet. Upon receiving a request to activate promotional interest rate, the system checks to determine if the consumer's 10 status is active and current (e.g., via demographic information database 32, account information database 34, etc.), the consumer's product code is defined to allow the promotional interest rate (e.g., via account information database 34, etc) and/or any other rules to verify or qualify the consumer 10 (step 206). If the consumer 10 qualifies for the promotional interest rate, the system changes the “Activate Flexible Intro (Y or N)” to Y (step 208), thereby allowing the finance charge calculator 25 to receive the instruction for substituting the set interest rate from the interest rate database with the promotional interest rate from the promotional interest rate database at the activation date and for the promotional time period 42 from promotional time periods database 42. The system may also provide an indication to other databases that any future requests for activating the promotional interest rate should be rejected (step 210). In an alternative embodiment, a different promotional interest rate may be available for cash purchases, merchandise purchases, introductory promotions, optional promotions and/or the like. Promotional interest rates 36 may also be available during different time periods for the same account number 14.

After the system receives a calendar date upon which to activate the promotional interest rate (step 212), the system stores the request in the activation date database (e.g., “Activation Date (YY/MM)”). When the promotional activation date 40 arrives, the system adjusts the set interest rate to be equivalent to the promotional interest rate such that the promotional interest rate is activated during the promotional time period (step 214). During this time period, the system then calculates a finance charge via finance charge calculator 25 based upon the promotional interest rate and bills the consumer 10 by applying the new finance charge to the unpaid balance on the account (step 216).

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. A method for facilitating the customization of a transaction card having a set interest rate using a host controller including a processor for processing digital data, a memory coupled to said processor for storing digital data, an input digitizer coupled to the processor for inputting digital data, an application program stored in said memory and accessible by said processor for directing processing of digital data by said processor, and at least one database, said at least one database including consumer data, transaction card data and set interest rate data, said method comprising:
receiving a promotional interest rate for said transaction card;
receiving a calendar date upon which to activate said promotional interest rate;
adjusting said set interest rate to be equivalent to said promotional interest rate such that said promotional interest rate is activated on said calendar date; and,
billing a finance charge based upon said promotional interest rate.

2. The method of claim 1, wherein adjusting said interest rate includes activating said promotional interest rate for at least one promotional time period requested by said consumer.

3. The method of claim 1, wherein said receiving a promotional interest rate for said transaction card includes receiving said promotional interest rate from said memory.

4. The method of claim 1, wherein said receiving a promotional interest rate for said transaction card includes receiving said promotional interest rate in a consumer request.

5. The method of claim 1, wherein using a host controller 22 includes using a controller operational within a smart card.

6. The method of claim 1, wherein said receiving a calendar date includes receiving said calendar date from memory.

7. The method of claim 1, wherein said receiving a calendar date includes receiving said calendar date in a consumer request.

8. A method for facilitating the customization of a transaction card having a set interest rate using a host controller including a processor for processing digital data, a memory coupled to said processor for storing digital data, an input digitizer coupled to the processor for inputting digital data, an application program stored in said memory and accessible by said processor for directing processing of digital data by said processor, and at least one database, said at least one database including consumer data, transaction card data and set interest rate data, said method comprising:
storing an available promotional interest rate associated with said transaction card, along with a promotional time period for activating said promotional interest rate;
receiving a calendar date upon which to activate said promotional interest rate;
adjusting said set interest rate to be equivalent to said promotional interest rate such that said promotional interest rate is activated on said calendar date and during said promotional time period; and,
billing a finance charge based upon said promotional interest rate.

9. A data processing system configured for facilitating the customization of a transaction card having a set interest rate, said system comprising
a controller including a processor for processing digital data, a memory coupled to said processor for storing digital data, an application program stored in said memory and accessible by said processor for directing processing of digital data by said processor;
at least one database including consumer data, transaction card data, set interest rate data, available promotional interest rate data associated with said transaction card, and promotional time period data;
said controller configured to receive a calendar date upon which to activate said promotional interest rate; and,
said controller configured to adjust said set interest rate to be equivalent to said promotional interest rate such that said promotional interest rate is activated on said calendar date and during said promotional time period.

10. The system of claim 9, wherein said controller is located on a smart card.
